(19) United States
(12) Patent Application Publication
(10) Pub. No.: US 2017/0220133 A1
(43) Pub. Date: Aug. 3, 2017

(54) ACCURATELY POSITIONING INSTRUMENTS

(71) Applicant: Hewlett-Packard Development Company, L.P., Houston, TX (US)

(72) Inventor: David Bradley Short, San Diego, CA (US)

(21) Appl. No.: 15/500,457

(22) PCT Filed: Jul. 31, 2014
(86) PCT No.: PCT/US2014/049018

§ 371 Date: Jan. 30, 2017

(51) Int. Cl. G06F 3/038; G06F 3/0354; G06F 3/0346; G06F 3/042

(52) U.S. Cl. CPC G06F 3/038; G06F 3/0425; G06F 3/0421; G06F 3/03545; G06F 3/0346

(57) ABSTRACT

Systems to accurately position an instrument includes an instrument with an interest point, an optical sensing system having a camera and a sensor coupled to a surface of the instrument, a motion detector, and a processor. The optical sensing system collects a set of optically-sensed positional data points. The motion detector collects a set of motion-sensed positional data points. The processor applies a correction function on the set of optically-sensed positional data points and on the set of motion-sensed positional data points to provide a set of corrected positional data points.

### BACKGROUND

The position of an instrument, such as an electronic writing stylus, can be detected optically with cameras or other sensing methods. An electronic writing stylus may be used in a number of applications, including recording digital handwriting, pointing devices, and tablets and touchscreens. Furthermore, the orientation of an instrument can be detected with motion detectors and other devices, such as accelerometers. Determining the orientation of an instrument can be useful in various applications, including applications involving three-dimensional input and output.

### BRIEF DESCRIPTION OF THE DRAWINGS

The following detailed description references the drawings, wherein:

FIG. 1 is a diagram of an example system to accurately position an instrument;

FIG. 2A is a diagram of an example system to accurately position an instrument including an optical sensing system having a plurality of cameras;

FIG. 2B is a diagram of an example system to accurately position an instrument including a plurality of motion detectors;

FIG. 3 is a diagram of an example system to accurately position an instrument including an emitter and a sensor having a retro-reflective surface;

FIG. 4A is a flowchart of an example method to accurately position an instrument;

FIG. 4B is a flowchart of an example method to accurately position an instrument including determining an offset;

FIG. 5 is a block diagram of an example computing device to accurately position a cylindrical writing apparatus.

### DETAILED DESCRIPTION

As described above, the position of an instrument may be determined with cameras or other optical detection devices or systems. The orientation of an instrument may be determined with motion detectors and other devices, such as accelerometers, gyroscopes, and magnetometers. Example applications for positioning an instrument include accurate writing with an electronic stylus. However, current methods and systems for determining the position of instruments presents several challenges.

Because optical systems typically use the detection of the instrument or a sensor by a camera, detection error may occur if the instrument or sensor becomes occluded. Furthermore, the precision of optically-sensed positional data is limited by the frame rate and exposure time of the camera, which generally share an inverse relationship. A desired high frame rate may give weak signals for each data point due to small exposure times. Slower frame rates may mean fewer data points, potentially leading to imprecise data. On the flipside, motion detectors may detect orientation and relative position of instruments to which they are attached. In order to provide accurate absolute positions, motion detectors may need to be frequently calibrated.

Examples described herein provide for accurately positioning an instrument. In example implementations, a system includes an instrument with an interest point, an optical sensing system to collect a set of optically-sensed positional data points, a motion detector coupled to the instrument to collect a set of motion-sensed positional data points, and a processor to apply a correction function on the set of optically-sensed positional data points and on the set of motion-sensed positional data points to provide a set of corrected positional data points. By using the two distinct sets of positional data points to supplement and correct each other, examples may provide a more accurate and precise set of corrected positional data points. In this manner, examples herein may accurately position an instrument.

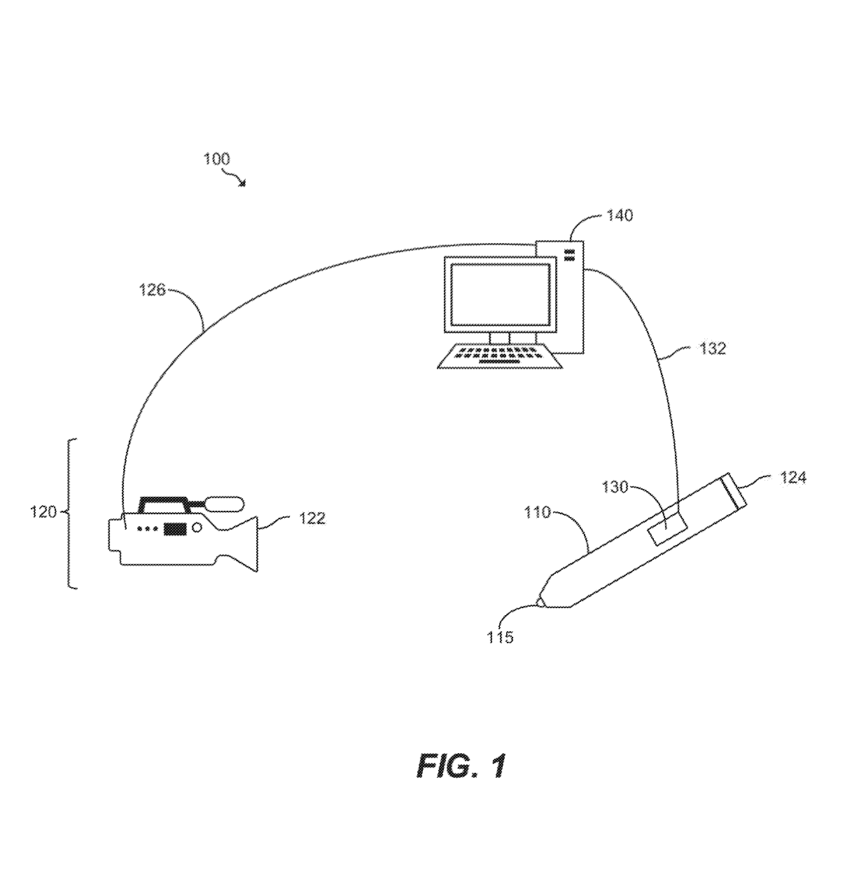

Referring now to the figures, FIG. 1 depicts an example system 100 to accurately position an instrument 110. System 100 may include the instrument 110, an optical sensing system 120, a motion detector 130, and a processor 140. Instrument 110 may have an interest point 115. Optical sensing system 120 may collect a set of optically-sensed positional data points and may have a camera 122 and a sensor 124. Motion detector 130 may collect a set of motion-sensed positional data points. Processor 140 may apply a correction function.

Instrument 110 may an object for which position may be determined. Instrument 110 may have an interest point 115, which may be the point for which a location is to be determined. In some examples, instrument 110 may be a cylindrical writing apparatus comprising a cylindrical body. Interest point 115 may be located on a lateral end of the cylindrical body of instrument 110. For example, instrument 110 may be an electronic writing device, such as a stylus. Interest point 115 may be a tip of the stylus, where virtual writing may be simulated. The position of the stylus tip may be determined to find the location of the writing point of the stylus.

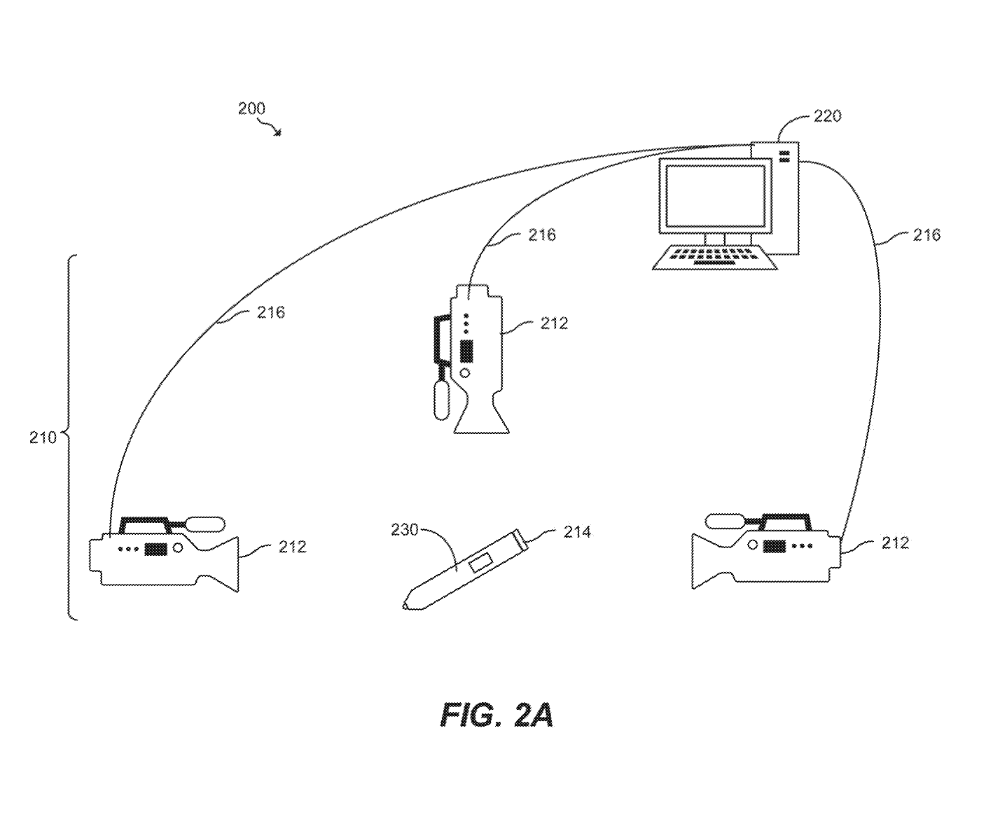

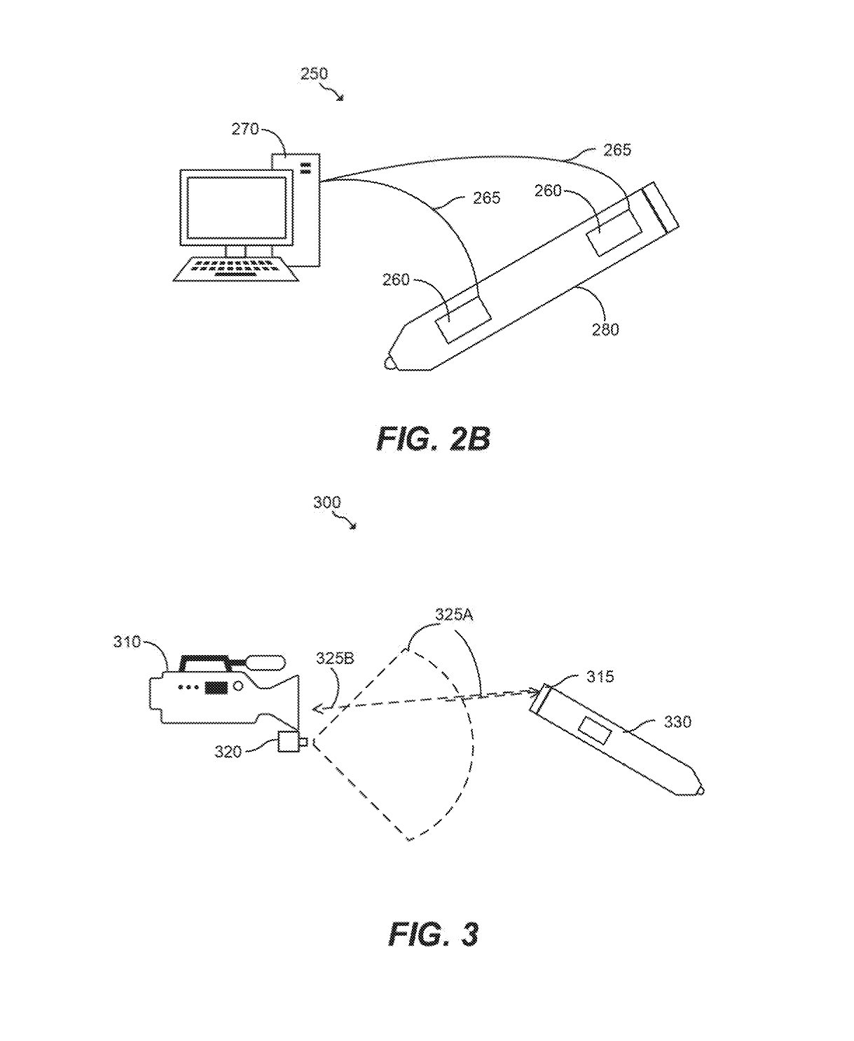

Optical sensing system 120 may collect a set of optically-sensed positional data points by using camera 122 to detect the position of sensor 124. Camera 122 may optically detect sensor 124. For example, camera 122 may detect electromagnetic radiation emanating from sensor 124. In some implementations, camera 122 may detect radiation originating from another source and reflected off of sensor 124. Alternatively or in addition, sensor 124 may emit radiation which may be detected by camera 122. Further details of the operation of camera 122 and sensor 124 is described below in relation to FIG. 2A and FIG. 3.

To detect the position of instrument 110, sensor 124 may be coupled to a surface of instrument 110. Because camera 122 may optically detect the location of sensor 124, occlusion problems may arise when the optical path between sensor 124 and camera 122 is blocked. For example, instrument 110 may be oriented at a given time so that sensor 124 may be occluded from view of camera 122. In a specific example where sensor 124 may be coupled to a side surface of the cylindrical body of a stylus, a user's hand may cover sensor 124 from detection by camera 122. Accordingly, in some examples, such as when instrument 110 is a cylindrical writing apparatus with a cylindrical body, sensor 124 may be coupled to a lateral end of the cylindrical body that is opposite the lateral end where interest point 115 may be located. Such an example is illustrated in FIG. 1. Such an orientation may minimize opportunities where sensor 124 may be occluded from view of camera 122.

After collecting a set of optically-sensed positional data points, optical sensing system 120 may transmit the set of optically-sensed positional data points to processor 140 via a data connection 126. Data connection 126 may a number of forms of communication, including via electrical wiring, optical wiring, and various forms of wireless data transmission such as Bluetooth. Furthermore, data connection 126 may transmit instructions from processor 140 to operate optical sensing system 120. In some examples, camera 122 and processor 140 may be a part of a computing device.

Motion detector 130 may collect a set of motion-sensed positional data points by detecting orientation and relative position of instrument 110. Motion detector 130 may be a device that senses or detects movement of the device and/or objects to which the device is coupled. In some implementations, motion detector 130 may have an accelerometer. An accelerometer may be a device that measures acceleration in the frame of reference of the accelerometer. For example, an accelerometer may measure the change in weight in relation to gravity of the earth. For example, a change in weight may register as a data point of acceleration. Acceleration data collected by motion detector 110 may be converted to position data through a conversion function such as by using double integration. Motion detector 110 may detect motion in multiple axes, and may have 6-axis or 9-axis motion sensors. In addition to an accelerometer, motion detector 110 may have a gyroscope, a magnetometer, or both.

After collecting a set of motion-sensed positional data points, motion detector 130 may transmit the set of motion-sensed positional data points to processor 140 via a data connection 132. Data connection 132 may a number of forms of communication, including via electrical wiring, optical wiring, and various forms of wireless data transmission. Furthermore, data connection 132 may transmit instructions from processor 140 to operate motion detector 130.

Processor 140 may apply a correction function on the set of optically-sensed positional data points collected by optical sensing system 120 and on the set of motion-sensed positional data points collected by motion detector 130 to provide a set of corrected positional data points. Processor 140 may be one or more central processing units (CPUs), semiconductor-based microprocessors, and/or other hardware devices suitable for execution of the correction function. In many examples, processor 140 may be a part of a computing device, which may be a notebook or desktop computer, a mobile device, a local area network (LAN) server, a web server, a cloud-hosted server, or any other suitable electronic device.

Processor 140 may apply the correction function in order to provide a set of corrected positional data points that is more accurate and precise than either or both of the set of optically-sensed positional data points and the set of motion-sensed positional data points. The correction function may execute a number of processes to provide the set of corrected positional data points. For example, in forming the set of corrected positional data points, the correction function may treat the set of optically-sensed positional data points as primary data points. The precision of the set of optically-sensed positional data points may be constrained by the frame rate of the positional data captured by camera 122. To improve precision, processor 140 may apply the correction function to interpolate using the set of motion-sensed positional data point to fill in any gaps or anomalies in the optically-sensed positional data.

In addition or as an alternative, the correction function may treat the set of motion-sensed positional data points as the primary data points. While motion detector 130 can detect orientation and movement, motion detector 130 may not be able to determine global position without calibration. Accordingly, processor 140 may apply the correction function to use the set of optically-sensed positional data points to calibrate the set of motion-sensed positional data points to provide the set of corrected positional data points. In some examples, the correction function may combine the set of optically-sensed positional data points and the set of motion-sensed positional data points into the set of corrected positional data points by applying weighing functions.

Furthermore, in some examples, processor 140 may determine an offset between interest point 115 of instrument 110 and sensor 124 of optical sensing system 120. Because camera 122 captures the location of sensor 124 and because sensor 124 may not be coupled in the same location on instrument 110 as interest point 115, the offset may be determined to accurately position interest point 115 relative to the location of sensor 124 captured by camera 122. The offset may be determined by a function that accounts for both optically-sensed positional data and motion-sensed positional data. Processor 140 may apply the correction function according to the offset to accurately position interest point 115.

In some examples, the set of optically-sensed positional data points may comprise two-dimensional positional data points. In such instances, camera 122 may be a top-down camera that captures location data on the x-axis and on the y-axis. Processor 140 may determine the offset between interest point 115 and sensor 124 of optical sensing system 120 by interpreting the motion-sensed positional data captured by motion detector 130. Furthermore, the set of motion-sensed positional data points may be used to fill in gaps in the set of optically-sensed positional data points. In a particular example, instrument 110 may be a writing stylus where interest point 115 is the writing tip of the stylus. Processor 140 may determine the offset between the location of sensor 124 and the writing tip by interpreting orientation of the writing stylus by using the motion-sensed positional data. In some examples, system 100 may include a writing surface. In such examples, the contact between interest point 115 and the writing surface may be used as a calibration point or as an additional source of positional data points.

In some other implementations, the set of optically-sensed positional data points may comprise three-dimensional positional data points. In such instances, camera 122 may be a depth camera that captures location data on the x-axis, the y-axis, and the z-axis. Processor 140 may apply the correction function to calibrate the set of optically-sensed positional data points and the set of motion-sensed positional data points. For example, system 100 may be used to accurately position a writing stylus 110 in airbrush mode where a user may virtually write or draw in three-dimensional space. Additionally, system 100 may be used to mark up a three-dimensional object by placing interest point 115 on the surface of the object. Processor 140 may utilize the set of optically-sensed positional data points and the set of motion-sensed positional data points to provide a set of corrected positional data points with improved accuracy and precision.

FIG. 2A depicts an example system 200 to accurately position an instrument 230, where system 200 includes an optical sensing system 210 with a plurality of cameras 212. Each camera 212 may collect a set of optically-sensed positional data points by detecting the location of a sensor 214 which may be coupled to a surface of instrument 230. Each camera 212 may then transmit the set of optically-sensed positional data points to a processor 220 via a data connection 216.

Processor 230 may combine the sets of optically-sensed positional data points into a combined set of optically-sensed positional data points. For example, processor 220 may determine each combined positional data point by triangulating the positional data points from one or more of the sets of optically-sensed positional data points collected by cameras 212. Having multiple cameras 212 may minimize occasions when sensor 214 may be occluded from view of any one of the cameras. Collecting multiple sets of optically-sensed positional data points may allow system 200 to provide a combined set of optically-sensed positional data points that may be more accurate and precise than any individual set.

FIG. 2B depicts an example system 250 to accurately position an instrument 280, where system 250 includes a plurality of motion detectors 260. Each motion detector 260 may be coupled to an instrument 280 for which position is to be determined. Each motion detector 260 may collect a set of motion-sensed positional data points by the use of accelerometers, gyroscopes, magnetometers, or other devices. Each motion detector may transmit the set of motion-sensed positional data points to a processor 270 via a data connection 265.

Processor 270 may combine the sets of motion-sensed positional data points into a combined set of motion-sensed positional data points. For example, processor 270 may average the data points from one or more of the sets of motion-sensed positional data points collected by motion detectors 260. Having multiple motion detectors 260 may improve accuracy of the orientation reading of instrument 280. Furthermore, having multiple sets of motion-sensed positional data may create redundancies that may help ensure an accurate position for instrument 280. It should be noted that in some implementations, system 200 and system 250 may be combined so that a system may have an optical sensing system with multiple cameras and multiple motion detectors.

FIG. 3 depicts an example system 300 to accurately position an instrument 330 including an emitter 320 and a sensor 315 having a retro-reflective surface which may be coupled to the surface of instrument 330. FIG. 3 illustrates an example implementation in which the optical sensing system of system 300 may collect a set of positional data points. In system 300, emitter 320 may emit electromagnetic radiation toward instrument 330, and camera 310 may receive electromagnetic radiation reflected from the retro-reflective surface of sensor 315 on instrument 330. In many examples, instrument 330 may be an electronic writing apparatus, such as a stylus.

Emitter 320 may be a device that exudes any signal, light, radiation, or any other type of signal. In some examples, emitter 320 may emit signal 325A toward the direction of instrument 330 in order to reflect the signal from sensor 315 into the capturing lenses of camera 310. In such an arrangement, sensor 315 does not require power to operate, and the energy used for creating signal 325A is from emitter 320. In some implementations, emitter 320 may emit an infrared signal 325A toward the direction of instrument 330 and sensor 315.

Sensor 315 may be a device that converts a physical quantity, such as physical position, into a signal 325B which can be captured by camera 310. For example, sensor 315 may send its location to camera 310 via an optical signal or some other form of communication. In some examples, sensor 315 may have a retro-reflective surface that reflects radiation or signals back to its source. For example, signal 325A emitted from emitter 320 may be reflected by the retro-reflective surface of sensor 315 toward camera 310. Reflected signal 325B may be captured by camera 310 as an optically-sensed positional data point. In some examples, emitter 320 may emit an infrared signal 325A. Infrared signal 325A may reach sensor 315 and may be reflected on sensor 315's retro-reflective surface. Reflected signal 325B may reach camera 310, providing the position data of sensor 315 at the time of reflection.

Alternatively or in addition, sensor 315 may itself emit a signal for capturing by camera 310. For example, sensor 315 may emit electromagnetic radiation, such as an infrared signal to be received by camera 310. In such examples, system 300 may or may not have an emitter 320. In such examples, sensor 315 may require power to operate which may be provided by a power source on instrument 330. In other examples where sensor 315 does not emit any signal but only reflects signals provided externally, no power source may be needed to operate sensor 315.

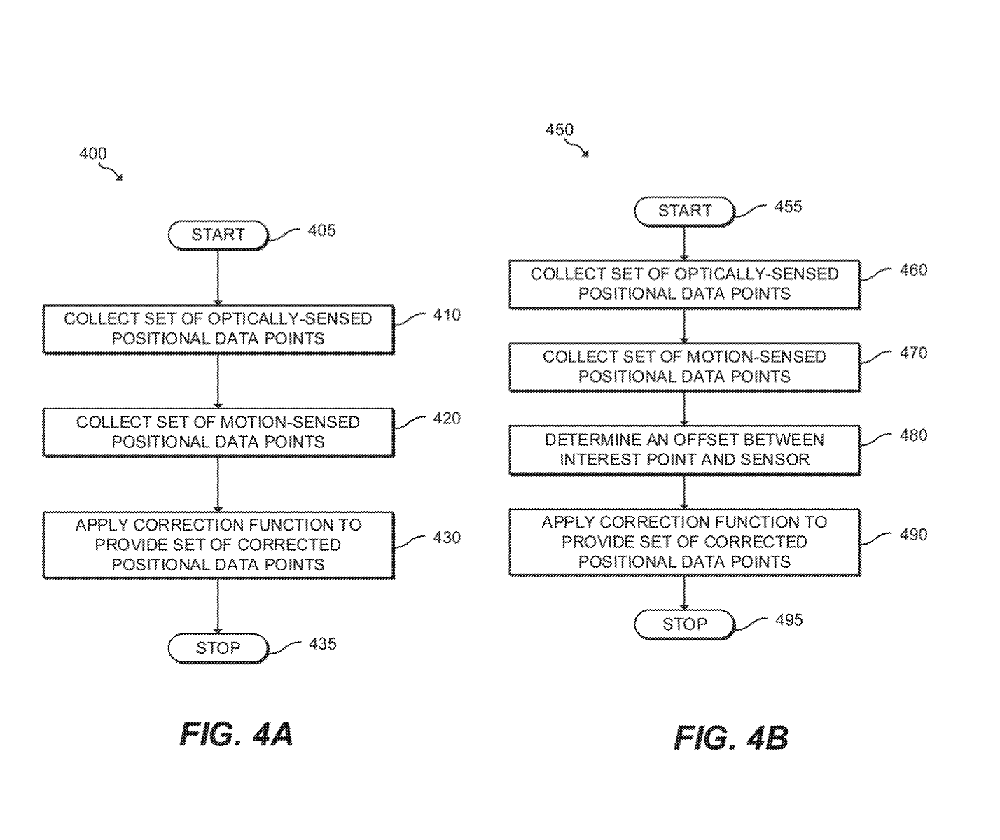

FIG. 4A is a flowchart depicting an example method 400 to accurately position an instrument, which may include block 410 for collecting a set of optically-sensed positional data points, block 420 for collecting a set of motion-sensed positional data points, and block 430 for applying a correction function to provide a set of corrected positional data points. Although execution of method 400 is herein described in reference to system 100 of FIG. 1, other suitable parties for implementation of method 400 should be apparent, including system 200 of FIG. 2A and system 250 of FIG. 2B.

Method 400 may start in block 405 and proceed to block 410, where a set of optically-sensed positional data points for instrument 110 is collected by optical sensing system 120. Instrument 110 may be, for example, a writing stylus with an interest point 115 as the writing tip of the stylus. The set of optically-sensed positional data points may be used to determine the position of the writing stylus 110 during virtually writing.

Optical sensing system 120 may include a camera 122 and a sensor 124 which is coupled to a surface of instrument 110. Sensor 124 may transit its position to camera 122, which may detect the positional data and transmit it to a processor 140 via a data connection 126. In some examples, optical sensing system 120 may include multiple cameras 122, each of which may collect a set of optically-sensed positional data points.

After collecting a set of optically-sensed positional data points, method 400 may proceed to block 420, where a set of motion-sensed positional data points is collected by motion detector 130 which may be coupled to instrument 110. Motion detector 130 may collect a set of motion-sensed positional data points by detecting orientation and relative position of instrument 110. Motion detector 130 may be a device that senses or detects movement of the device and/or objects to which the device is coupled. In some implementations, motion detector 130 may include at least one of an accelerometer, gyroscope, and magnetometer. Motion detector 110 may detect motion in multiple axes, and may have 6-axis or 9-axis motion sensors. Motion detector 130 may also transmit collected sets of motion-sensed positional data points to processor 140 via a data connection 132. In some examples, system 100 may have a plurality of motion detectors 130, each coupled to instrument 110 and each collecting a set of motion-sensed positional data points.

After collecting a set of motion-sensed positional data points, method 400 may proceed to block 430, where processor 140 applies a correction function to the set of optically-sensed positional data points and to the set of motion-sensed position data points to provide a set of corrected positional data points. As described above in relation to FIG. 1, processor 140 may apply the correction function in order to provide a set of corrected positional data points that is more accurate and precise than either or both of the set of optically-sensed positional data points and the set of motion-sensed positional data points. The correction function may execute a number of processes to provide the set of corrected positional data points. For example, in some examples, the correction function may combine the set of optically-sensed positional data points and the set of motion-sensed positional data points into the set of corrected positional data points by applying weighing functions. After providing a set of corrected positional data points, method 400 may proceed to block 435 to stop.

FIG. 4B is a flowchart depicting example method 450 to accurately position an instrument including determining an offset. Method 450 may include block 460 for collecting a set of optically-sensed positional data points, block 470 for collecting a set of motion-sensed positional data points, block 480 for determining an offset between an interest point and a sensor, and block 490 for applying a correction function to provide a set of corrected positional data points. Although execution of method 450 is herein described in reference to system 100 of FIG. 1, other suitable parties for implementation of method 400 should be apparent, including system 200 of FIG. 2A and system 250 of FIG. 2B.

Method 450 may start in block 455 and proceed to block 460, where optical sensing system 120 collects a set of optically-sensed positional data points. Block 460 may be similar to block 410 of method 400. Method 450 may then proceed to block 470, where motion detector 130 collects a set of motion-sensed positional data points. Block 470 may be similar to block 420 of method 400.

After collecting a set of optically-sensed positional data points and a set of motion-sensed positional data points, method 450 may proceed to block 480, where processor 140 may determine an offset between interest point 115 of instrument 110 and sensor 124. As described above in relation to FIG. 1, camera 122 captures the location of sensor 124, which may not be coupled in the same location as interest point 115. The offset may be determined to accurately position interest point 115 relative to the location of sensor 124 captured by camera 122. The offset may be determined by a function that accounts for both optically-sensed positional data and motion-sensed positional data.

After determining an offset, method 450 may proceed to block 490, where processor 140 applies a correction function to the set of optically-sensed positional data points and to the set of motion-sensed position data points to provide a set of corrected positional data points. As described above in relation to FIG. 1, in some examples, processor 140 applies the correction function to calibrate the set of optically-sensed positional data points and the set of motion-sensed positional data points. Furthermore, processor 140 may apply the correction function according to the offset determined in block 480 to accurately position interest point 115. After applying the correction function and providing the set of corrected positional data points, method 400 may proceed to block 495 to stop.

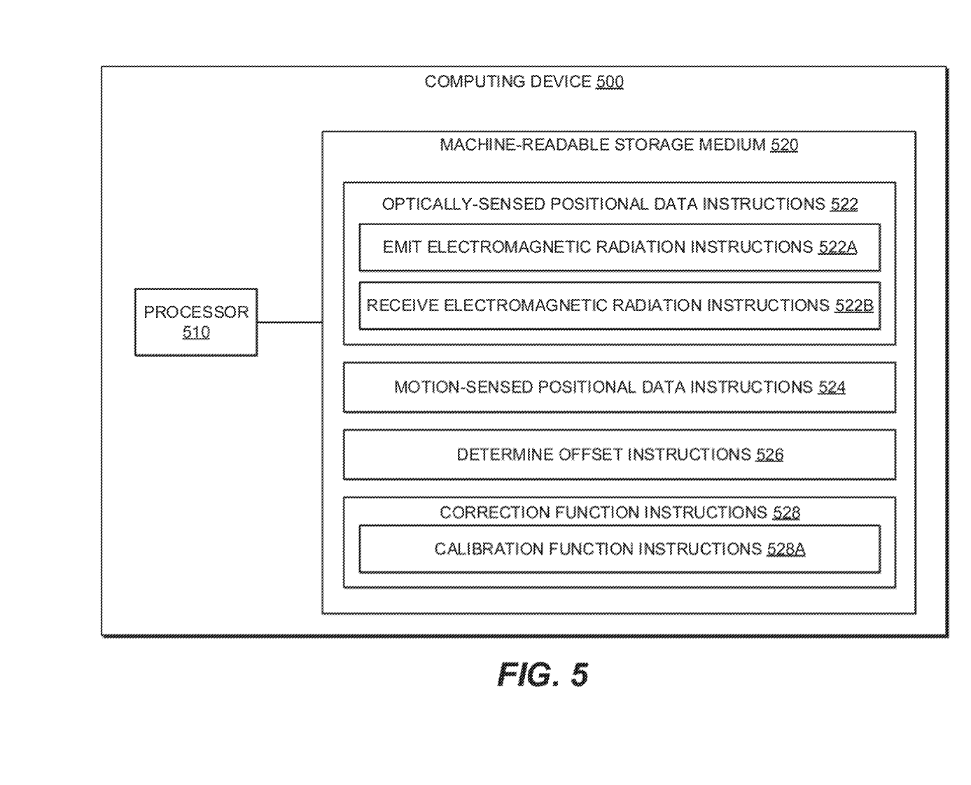

FIG. 5 depicts an example computing device 500 to accurately position a cylindrical writing apparatus. Computing device 500 may be, for example, a notebook or desktop computer, a mobile device, a local area network (LAN) server, a web server, a cloud-hosted server, or any other electronic device that may accurately position a cylindrical writing apparatus in the manner of the examples described herein. In the implementation shown in FIG. 5, computing device 500 includes a processor 510 and a non-transitory machine-readable storage medium 520 encoded with instructions to accurately position a cylindrical writing apparatus executable by processor 510. In some implementations, computing device 500 may be a part of a system, such as system 100 of FIG. 1.

Processor 510 may be one or more central processing units (CPUs), semiconductor-based microprocessors, and/or other hardware devices suitable for retrieval and execution of instructions stored in machine-readable storage medium 520. Processor 510 may fetch, decode, and execute instructions 522, 524, 526, 528 to implement the procedures described below. As an alternative or in addition to retrieving and executing instructions, processor 510 may include one or more electronic circuits that include electronic components for performing the functionality of one or more of instructions 522, 524, 526, 528.

Machine-readable storage medium 520 may be any electronic, magnetic, optical, or other physical storage device that contains or stores executable instructions. Thus, machine-readable storage medium 520 may be, for example, Random Access Memory (RAM), an Electrically Erasable Programmable Read-Only Memory (EEPROM), a storage device, an optical disc, and the like. Storage medium 520 may be a non-transitory storage medium, where the term “non-transitory” does not encompass transitory propagating signals. As described in detail below, machine-readable storage medium 520 may be encoded with optically-sensed positional data instructions 522, motion-sensed positional data instructions 524, determine offset instructions 526, and correction function instructions 528.

Machine-readable storage medium 520 may include optically-sensed positional data instructions 522, which may receive sets of optically-sensed positional data points collected by an optical sensing system, such as system 120 of FIG. 1. Optically-sensed positional data instructions 522 may include emit electromagnetic radiation instructions 522A and receive electromagnetic radiation instructions 522B. Emit instructions 522A may cause an emitter, such as emitter 320 of FIG. 3, to emit electromagnetic radiation toward the cylindrical writing apparatus to be positioned. The electromagnetic radiation may reach a sensor, such as sensor 315, coupled to the cylindrical writing apparatus. The sensor may have a retro-reflective surface that reflects the electromagnetic radiation back toward the sensor and a camera of the optical sensing system. Receive instructions 522B may cause the camera to receive the electromagnetic radiation. Detailed examples of using an emitter to collect optically-sensed positional data are described above in relation to FIG. 3.

Machine-readable storage medium 520 may also include motion-sensed positional data instructions 524, which may receive sets of motion-sensed positional data points collected by a motion detector, such as motion detector 130 of FIG. 1. Detailed examples of collecting a set of motion-sensed positional data points are described above in relation to FIG. 1 and FIG. 2B.

Machine-readable storage medium 520 may also include determine offset instructions 526, which may determine an offset between an interest point on the cylindrical writing apparatus and a sensor coupled to the cylindrical writing apparatus. As described above in relation to FIG. 1, the camera of the optical sensing system captures the location of the sensor, which may not be coupled in the same location as an interest point of the cylindrical writing apparatus. The offset may be determined to accurately position the interest point relative to the location of the sensor captured by the camera. Determine offset instructions 526 may include executing a function that accounts for both optically-sensed positional data and motion-sensed positional data.

Furthermore, machine-readable storage medium 520 may include correction function instructions 528, which may apply a correction function on the set of optically-sensed positional data points and on the set of motion-sensed positional data points to provide a set of corrected positional data points. Correction function instructions 528 may apply the correction function according to the offset. Furthermore, correction function instructions 528 may include calibration function instructions 528A, which, as described in detail above, may calibrate the set of optically-sensed positional data points and the set of motion-sensed positional data points.

What is claimed is:

1. A system to accurately position an instrument, comprising:
the instrument, wherein the instrument comprises an interest point;
an optical sensing system to collect a set of optically-sensed positional data points, wherein the optical sensing system comprises a camera and a sensor, wherein the sensor is coupled to a surface of the instrument;
a motion detector coupled to the instrument to collect a set of motion-sensed positional data points; and
a processor to apply a correction function on the set of optically-sensed positional data points and on the set of motion-sensed positional data points to provide a set of corrected positional data points.

2. The system of claim 1, wherein the processor determines an offset between the interest point of the instrument and the sensor of the optical sensing system, and wherein the processor applies the correction function according to the offset.

3. The system of claim 2, wherein the set of optically-sensed positional data points comprises two-dimensional positional data points, and wherein the processor determines the offset between the interest point and the sensor by interpreting the set of motion-sensed positional data points.

4. The system of claim 2, wherein the set of optically-sensed positional data points comprises three-dimensional positional data points, and wherein correction function calibrates the set of optically-sensed positional data points and the set of motion-sensed positional data points.

5. The system of claim 1, wherein:
the instrument is a cylindrical writing apparatus comprising a cylindrical body;
the interest point is located on a lateral end of the cylindrical body; and
the sensor of the optical sensing system is coupled on an opposite lateral end of the cylindrical body.

6. The system of claim 1, wherein:
the optical sensing system comprises a plurality of cameras;
each camera collects a set of optically-sensed positional data points; and
the processor combines the sets of optically-sensed positional data points into a combined set of optically-sensed positional data points.

7. The system of claim 1, comprising a plurality of motion detectors coupled to the instrument, wherein:
each motion detector collects a set of motion-sensed positional data points; and
the processor combines the sets of motion-sensed positional data points into a combined set of motion-sensed positional data points.

8. The system of claim 1, wherein:
the optical sensing system comprises an emitter to emit electromagnetic radiation toward the instrument;
the sensor comprises a retro-reflective surface; and
the camera receives electromagnetic radiation reflected from the retro-reflective surface of the sensor.

9. The system of claim 1, wherein the sensor of the optical sensing system comprises an emitter to emit electromagnetic radiation, and wherein the camera receives electromagnetic radiation emitted from the sensor.

10. A method to accurately position an instrument, comprising:
collecting a set of optically-sensed positional data points;
collecting a set of motion-sensed positional data points; and
applying a correction function on the set of optically-sensed positional data points and on the set of motion-sensed positional data points to provide a set of corrected positional data points.

11. The method of claim 10, wherein:
the set of optically-sensed positional data points is collected by an optical sensing system comprising a camera and a sensor, wherein the sensor is coupled to a surface of the instrument; and
the set of motion-sensed positional data points is collected by a motion sensing system comprising a motion detector coupled to the instrument.

12. The method of claim 11, comprising determining an offset between an interest point of the instrument and the sensor of the optical sensing system, wherein the correction function is applied according to the offset.

13. The method of claim 12, wherein the correction function calibrates the set of optically-sensed positional data points and the set of motion-sensed positional data points.

14. A computing device to accurately position a cylindrical writing apparatus, comprising a processor to:
receive a set of optically-sensed positional data points of the cylindrical writing apparatus;
receive a set of motion-sensed positional data points of the cylindrical writing apparatus;
determine an offset between an interest point on the cylindrical writing apparatus and a sensor coupled to the cylindrical writing apparatus;
apply a correction function on the set of optically-sensed positional data points and on the set of motion-sensed positional data points to provide a set of corrected positional data points, wherein the correction function is applied according to the offset and wherein the correction function calibrates the set of optically-sensed positional data points and the set of motion-sensed positional data points.

15. The computing device of claim 14, wherein the sensor coupled to the cylindrical writing apparatus comprises a retro-reflective surface, and wherein the processor receives the set of optically-sensed positional data points by:
causing an emitter to emit electromagnetic radiation toward the cylindrical writing apparatus; and
causing a camera to receive electromagnetic radiation reflected from the retro-reflective surface of the sensor.
